(19) United States
(12) Patent Application Publication
(10) Pub. No.: US 2009/0290279 A1
(43) Pub. Date: Nov. 26, 2009

(54) GROUNDING ELECTRODE

(75) Inventors: Francisco J. Rodgriguez, Austin, TX (US); Jerome T. Gosselin, Austin, TX (US); Justine A. Mooney, Austin, TX (US); Brent Beamer, Sanford, NC (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/469,401

(22) Filed: May 20, 2009

Related U.S. Application Data
(60) Provisional application No. 61/055,632, filed on May 23, 2008.
(60) Provisional application No. 61/099,824, filed on Sep. 24, 2008.

(51) Int. Cl. H05F 3/02

(52) U.S. Cl. 361/220

(57) ABSTRACT

Provided is an electrode having an insulating backing, a conductive path extending from a first major surface to a second major surface of the insulating backing, and an adhesive on at least one surface of the backing, wherein the electrode is attached to a grounding wire that is in electrical contact with the conductive path of the electrode.

### CROSS REFERENCE TO RELATED APPLICATIONS

This application claims the benefit of U.S. Provisional Patent Application Nos. 61/055,632, filed May 23, 2008 and 61/099,824 filed Sep. 24, 2008, the disclosure of which is incorporated by reference herein in its entirety.

### BACKGROUND

It is well known that when operating equipment or working with a component that is sensitive to electrostatic discharge, operators must be grounded to prevent electrostatic damage to the sensitive equipment/component. Guidelines such as ANSI/ESDA S.20.20 standards (available at www.esda.org) provide requirements for operators to be grounded. These guidelines are typically met by requiring each operator to wear a wristband that is electrically connected to a grounding jack.

An electrically conductive wrist strap is a well known device that grounds an individual, workbench or tool in environments in which electrostatic discharge (ESD) is a concern, such as disk drive assembly, GMR head handling, a semiconductor fabrication/assembly process, reticle handling, flat panel fabrication, laser diodes/fiberoptics, electronic assembly, industrial robots, medical and military applications. The electrically conductive wrist strap, worn by an operator, is electrically connected to a grounded object by a ground cord. The wrist strap system is used to “drain” or dissipate an electrical charge from a person to ground through the wristband and the ground cord. This prevents damage to the articles being handled by the operators due to electrostatic discharge from the operator to the article. Most ESD wrist strap systems currently use a wrist band that is made primarily of plastic or fabric and has conductive elements.

### SUMMARY

At least one embodiment the present invention provides a grounding device comprising an electrode that is attached to, and in electrical contact with, an object to be grounded, the electrode further being in electrical contact with a conductive wire, and the wire being in electrical contact with a grounded object. The object to be grounded may be a person, a device, a piece of equipment, or some other object. The electrode may be attached to the object to be grounded by an adhesive, typically a conductive adhesive. If the object to be grounded is a person, the adhesive may be biocompatible. The conductive wire may be in permanent or releasable electrical contact with the electrode. Releasable electrical contact may be obtained with a fastening mechanism such as a snap, clasp, or clip. The electrode may be in electrical contact with one or more conductive wires.

Another embodiment of the present invention provides an electrode attached to a substrate for use as a docking station for a grounding conductive wire that is not in use, i.e., not connected to an object to be grounded. The electrode may be attached to the substrate by the same type of adhesive as would be suitable for the previous embodiment.

Another embodiment of the present invention provides a system comprising a conductive wire, each end of the wire being in electrical contact with an electrode. The electrodes may be attached to two different objects to bring them to the same electrical potential. As with the previous embodiment, the objects to be connected include a person, a device, a piece of equipment, or some other object. The electrodes may be attached to the objects by the same type of adhesive as would be suitable for the previous embodiment.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of an embodiment of a grounding system according to the present invention.

FIG. 2 is a top view of an embodiment of a grounding electrode according to the present invention.

FIG. 3 is a cross-sectional exploded view of the grounding electrode of FIG. 2.

FIG. 4 is a top view of an embodiment of a grounding electrode according to the present invention.

FIG. 5 is a cross-sectional view of the grounding electrode of FIG. 4.

FIG. 6A is a cross-sectional view of an embodiment of a grounding electrode of the present invention.

FIG. 6B is a cross-sectional view of an embodiment of a grounding electrode of the present invention.

FIG. 7A is a cross-sectional view of an embodiment of a grounding electrode of the present invention.

FIG. 7B is a cross-sectional view of an embodiment of a grounding electrode of the present invention.

FIG. 8 is a cross-sectional view of an embodiment of a grounding electrode of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

In this specification, the phrases “comprising a . . . ” and “comprising an . . . ” are each to mean a set including one or more.

Embodiments of the invention provide a grounding method and device different from wrist strap devices. Embodiments of the present invention connect a conductive grounding wire to a person or object using an adhering grounding electrode. The adhering grounding electrode can be placed anywhere on the human body, not just the wrist. This is beneficial for people having a higher electrical resistance on their wrists than on other areas of their bodies. Embodiments of the present invention allow the conductive grounding wire to be connected to the person at a place on the body that has less resistance than the wrist. Embodiments of the invention may also be more comfortable to the user than a wrist strap. Wearing a wrist strap on the same wrist all the time may become uncomfortable. Embodiments of the present invention allow the location of connection to be changed frequently, which can decrease discomfort over the long-term. Additionally, the flexibility of the grounding electrode can be tailored to its particular use. For example, if a grounding electrode will be worn on an area of a person's body that will bend or will be attached to an uneven surface, the grounding electrode can be made of materials that allow it to conform, or substantially conform, to the shape of the surface to which it is adhered.

Embodiments of the present invention also are advantageous over re-usable wrist straps because the grounding electrode can be made for a single use and can be discarded after removal. In contrast, re-usable wrist strap may collect contaminants such as sweat and dirt. The reusable wrist strap will provide varying levels of conductivity based on the resistance of the strap itself and the person wearing the strap. The resistance of the strap is determined by the materials with which it is made. Also, the conditions and methods of using the strap have an effect on the overall resistance: The operator may be wearing a soiled strap fabric that will limit the strap's electrical conductivity. The strap may be improperly worn such that it is loose and does not make sufficient contact with the operator. The strap may be in contact with the operator's dry skin, which will increase the electrical resistance. The operator may have excessive arm hair which will also increase the electrical resistance.

The use of the grounding electrode of the present invention can reduce or alleviate these issues. For example, the grounding electrode can be placed on an area of the body that has limited body hair. Additionally, an electrically conductive adhesive can be used to bond the grounding electrode to the body, which can increase and improve the electrical contact between the grounding electrode and the operator because the adhesive's moisture increases the conductivity by minimizing the dry conditions on the skin's surface.

While the grounding electrodes may be particularly suitable to provide ground contact for a human operator, they are also well suited for other uses such as providing a grounding contact for electrostatic sensitive equipment and products, as well as electrostatic discharge (ESD) surfaces such as mats, floors, and tabletops. When the grounding electrodes are used with an inanimate object, the adhesive can be tailored to be repositionable or attach so strongly as to be considered a “permanent” grounding point. The adhesive can also be tailored to operate in adverse operating conditions such as wet/humid/high temperature conditions, such as would occur in outdoor applications.

Any suitable adhesive may be used to adhere the grounding electrode to the person or object to be grounded. While the adhesive will most typically be adhered to a person, it may also be adhered to surfaces, equipment, articles, etc. The suitability of any particular adhesive will depend on the intended use. The desired adhesion properties may vary depending on whether the grounding electrode will be adhered to human skin, metal, plastic, etc. and will further depend on whether the grounding electrode will be removed periodically, e.g., daily, weekly, or monthly, or whether it is intended to remain adhered for longer periods. Biocompatible pressure sensitive adhesives are typically the most suitable type of adhesive for adhering the grounding electrodes to an operator or other person. For high performance adhesion to a variety of industrial substrates, the pressure sensitive adhesive properties are typically at least 10 Newtons/100 mm because this amount of tack is quite acceptable for general purpose adhesiveness. For high performance adhesion to mammalian skin, the pressure sensitive adhesive properties are typically about 15-25 Newtons/100 mm, more typically about 20 Newtons/100 mm. For high performance aggressive adhesion, the pressure sensitive adhesive properties can be at least 30, 40, 50, or 60 Newtons/100 mm depending on the 180 DEG peel adhesion strength desired for structural adhesives to a variety of substrates.

Polymerized microemulsion PSAs are suitable for use in the present invention, particularly when adhesion to mammalian skin is involved. The polymerized microemulsion PSAs have defined pressure sensitive adhesive properties using the PSTC-1 Test of at least 3 Newtons/100 mm. These defined pressure sensitive adhesive properties apply whether the polymer is hydrated (i.e., “wet” adhesion) or dehydrated (i.e., “dry” adhesion). Desirably, for high performance adhesion to a variety of surfaces, the pressure sensitive adhesive properties is at least 4 Newtons/100 mm because that amount of 180 DEG peel adhesion strength is needed to provide adequate adhesiveness for almost all commercial adhesive usage.

With the variety of polymerized microemulsion PSAs possible based on the disclosure of U.S. Pat. No. 5,670,557, the disclosure of which is incorporated herein by reference, almost any value of pressure sensitive adhesive properties can be constructed, tailored to meet the needs of the desired usage. The common denominator for the polymerized microemulsion PSAs is their minimum 180 DEG peel adhesion of at least 3 Newtons/100 mm and typically greater peel adhesion strength.

As will be explained in more detail below, the adhesives are typically conductive, but non-conductive adhesives may also be used in conjunction with conductive adhesives.

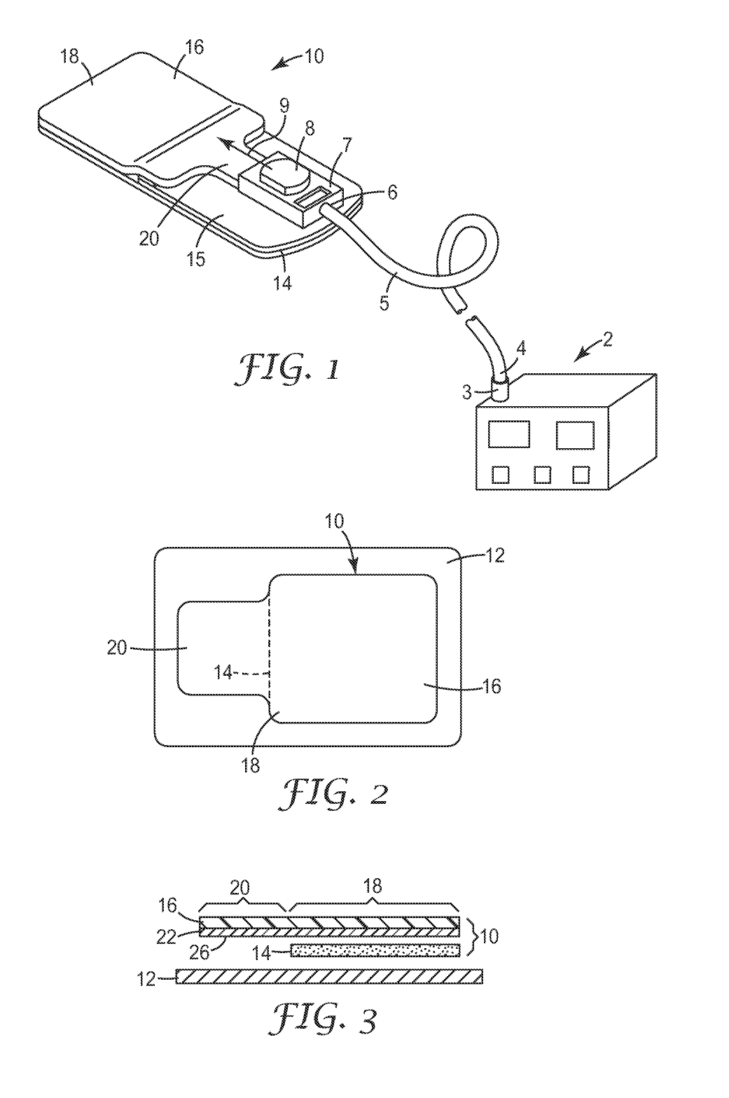

FIG. 1 illustrates an embodiment of a grounding electrode 10 according to an embodiment of the present invention. The grounding electrode 10 is depicted in perspective, and is shown in association with electrically grounded object 2, such as a grounding instrument. Grounded object 2 can be portable, mobile, or stationary.

Electrical communication between grounding electrode 10 and grounded object 2 is generally provided by means of a grounding wire 5 having a first end 6 attached to a clip 7, and a second end 4 attached to a jack 3, or the like, for engagement with grounded object 2. A variety of clips 7 may be used. The one shown in FIG. 1, includes a thumb operated cam 8 which, when slid in the direction indicated by arrow 9, causes gripping of a thin, flat member, such as a tab portion of grounding electrode 10 described below. Clip 7 is described in U.S. Pat. No. 4,700,997 (Strand), the disclosure of which is incorporated by reference herein. Other useful clips include ‘alligator’ clips commonly used in the art and described in U.S. Pat. No. 4,842,558 (Strand) the disclosure of which is incorporated by reference herein. Alternatively, the mechanical and electrical contact at the tab portion of the grounded electrode can be pre-wired to a grounding wire 5.

In other embodiments, any type of suitable mechanical fixing system may be used to connect grounding wire 5 to grounding electrode 10. The mechanical fixing system may be any type of mechanism having one or more parts that would establish and maintain grounding wire 5 in electrical contact with grounding electrode 10, and optionally release it in response to a disengaging force. For example, the mechanical fixing system may include a spring-loaded contact so that the mechanical fixing system can be engaged or disengaged as two mating parts are connected or disconnected, respectively. The mechanical fixing system typically either has an electrically conductive section, or accommodates an electrically conductive article or element, that provides an electrical path from the grounding electrode to grounding wire 5 when the mechanical fixing system is engaged.

Additionally, instead of, or in addition to, providing an electrical connection to ground, the grounding electrode may also be used to provide electrical contact between an operator and a device or piece of equipment to ensure the device/equipment and operator are at the same electrical potential. In this embodiment, a conductive wire would have an attachment feature on both ends that would connect to a mating attachment feature on the grounding electrode so that the conductive wire could connect two grounding electrodes—one attached to the operator and one attached to the device/equipment. This can prevent electrical discharges between the operator and the device/equipment.

The grounding electrode may connect to a single wire or multiple wires. Typically the grounding electrode will connect to one or two wires. The use of one and two wires is often referred to as single cord and dual cord constructions. A dual cord construction would typically be used when a DC circuit is desired. The grounding electrode of FIG. 1 includes two primary non-adhesive components: a flexible separator layer 15 and a substantially flat, flexible, conductor member 16. Conductor member 16 generally includes a tab portion 20 and a conductive pad portion 18. The conductor member 16 is oriented relative to the separator layer 15 such that the conductive pad portion 18 is substantially coplanar with the separator layer 15 and the tab portion 20 is generally above the plane of the separator structure 15 and the conductive pad portion 18. Conductive adhesive 14 is adhered to the bottom of conductive pad portion 18 and separator structure 15. Separator structure 15 is located between a portion of the conductor member 16 and contacting conductive adhesive 14 so that only pad portion 18 contacts conductive adhesive 14.

FIGS. 2 and 3 show another embodiment of a grounding electrode 10 on a release liner 12. If grounding electrode 10 will be attached to a person, it will typically include a conductive adhesive 14 that is biocompatible for contacting mammalian skin. Grounding electrode 10 may be adhered to the skin of an operator upon removal of protective release liner 12. Grounding electrode 10 includes means for electrical communication comprising a conductor member 16 having a conductive pad portion 18 contacting conductive adhesive 14 and a tab portion 20 extending beyond conductive adhesive 14 for mechanical and electrical connection to a grounded instrument (not shown). In this embodiment, conductor member 16 includes a conductive layer 26 coated on at least the side 22 of conductor member 16 that faces conductive adhesive 14.

A typical conductor member 16 may comprise a strip of material having a thickness of about 0.05-0.2 millimeters, such as polyester film and have a coating 26 on side 22 of silver/silver chloride of about 2.5-12 micrometers, and typically about 5 micrometers thick thereon. Presently preferred for conductor member 16 are polyester films commercially available as SCOTCHPAR from 3M Company of St. Paul, Minn. or commercially available as MELINEX 505-300, 329, or 339 film from ICI Americas of Hopewell, Va. coated with a silver/silver chloride ink commercially available as R-300 ink from Ercon, Inc. of Waltham, Mass. A conductor member 16 can be made of a non-woven web, such as a web of polyester/cellulose fibers commercially available as MANNIWEB web from Lydall, Inc. of Troy, N.Y. and have a conductive layer 26 commercially available as SS24363 ink from Acheson Colloids Company of Port Huron, Mich. on side 22 thereof. To enhance mechanical contact between an electrode clip (not shown) and conductor member 16, an adhesively-backed polyethylene tape can be applied to tab portion 20 on the side opposite side 22 having the conductive coating 26. A surgical tape commercially available from 3M Company as BLENDERM tape can be employed for this purpose.

In another embodiment conductor member 16 may be a multi-layered construction of a nonconductive, flexible polymeric film having a sulfur-reactive surface, a metallic layer deposited on and interacting with the surface and an optional metallic halide layer, according to the disclosure of U.S. Pat. No. 5,506,059, the disclosure of which is incorporated herein by reference. The conductive pad portion 18 of conductor member 16 may comprise a metallic layer deposited on a sulfur-reactive surface on at least the side of polymeric film substrate facing conductive adhesive 14 and the optional metallic halide layer coated on the metallic layer. Because depolarizing is not needed for the mechanical and electrical contact with electrical equipment, optional metallic halide layer need not extend to tab portion 20.

In another embodiment conductor member 16 may be a multi-layered construction of a nonconductive, flexible polymeric film, an electrically conductive layer, and a thin, conformable depolarizing layer of inorganic oxide, typically manganese dioxide. Alternatively, conductor member 16 may be a multi-layered construction of film with electrically conductive and depolarizing layers blended together. Both of these alternative embodiments can be constructed according to the disclosure of U.S. Pat. No. 5,505,200, the disclosure of which is incorporated by reference herein. The conductive interface portion of conductor member 16 comprises an electrically conductive layer coated on at least the side of polymeric film facing conductive adhesive 14 and the thin, depolarizing layer coated on the electrically conductive layer. Because depolarizing is not needed for the mechanical and electrical contact with electrical equipment, depolarizing layer need not extend to tab portion 20.

Other non-limiting examples of ground electrodes include electrodes disclosed in U.S. Pat. Nos. 4,524,087; 4,539,996; 4,554,924; 4,848,353 (all Engel); 4,846,185 (Carim); 4,771,713 (Roberts); 4,715,382 (Strand); 5,012,810 (Strand et al.); and 5,133,356 (Bryan et al.), the disclosures of which are incorporated by reference herein.

Commercially available electrodes that could be modified to provide a suitable ground electrode of the present invention include those available under the trade designations 3M RED DOT 2284 Pre-Wired Neonatal Limb Band ECG Monitoring Electrode, 3M RED DOT 2282L Pre-Wired Neonatal ECG Monitoring Electrode, 3M RED DOT 2269T Pre-Wired Neonatal ECG Monitoring Electrode, and 3M RED DOT Monitoring Electrode 2360, Resting Tab, all of which are available from 3M Company, St. Paul, Minn. These electrodes could be used as pre-wired grounding electrodes, or could be modified to provide a feature that allows the wire to be attached and detached as described in other embodiments of the invention.

The means for electrical communication between the grounding electrode and the grounding wire can be any suitable means that connects the electrode to the wire securely enough to maintain an electrical connection between the two. For example, the means could be any suitable type of mechanical fastener such as a snap fastener, mating clasp, tab and slot combination, tab and clip combination, or an adhesive. In some instances, the means for electrical communication can be an electrically conductive tab extending from the periphery of the ground electrode such as that seen in U.S. Pat. No. 4,848,353 or can be a conductor member extending through a slit or seam in an insulating backing member, such as that seen in U.S. Pat. No. 5,012,810. Otherwise, the means for electrical communication can be an eyelet or other snap-type connector such as that disclosed in U.S. Pat. No. 4,846,185. Further, the means for electrical communication can be a grounding wire such as that seen in U.S. Pat. No. 4,771,783, the disclosure of which is incorporated herein by reference.

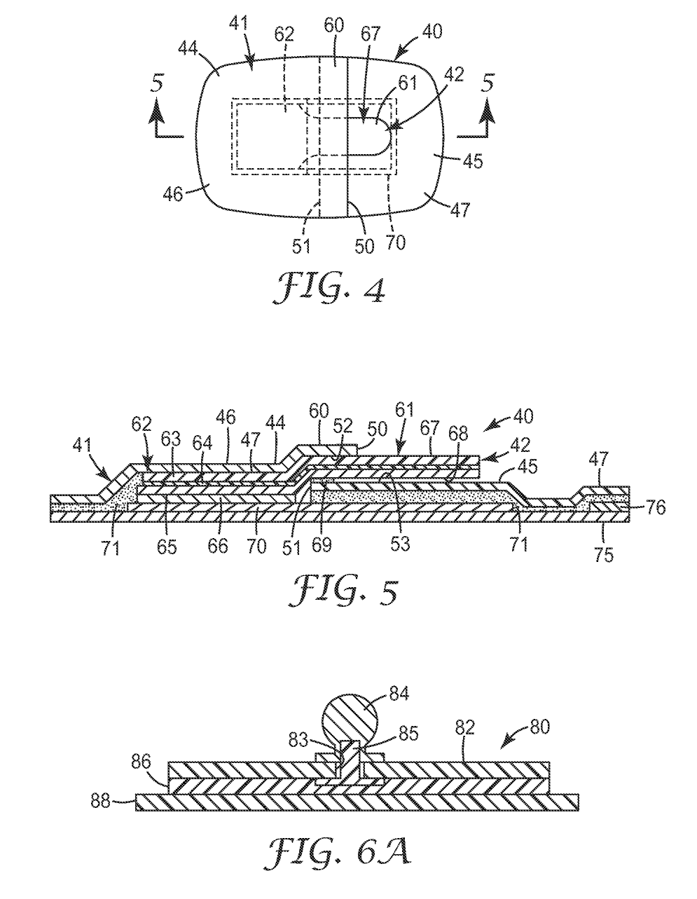

Another suitable ground electrode structure is disclosed in U.S. Pat. No. 5,012,810 (Strand et al.). A biocompatible adhesive can be used as the conductive medium in any of the embodiments shown therein. FIGS. 4 and 5 of the present specification substantially correspond to FIGS. 2 and 3, respectively, of U.S. Pat. No. 5,012,810. Ground electrode 40 includes an insulator layer 41, and a conductor member 42.

The insulator layer 41 includes first and second sections 44 and 45 which, together, define opposite sides 46 and 47 of the insulator layer 41. As seen in FIG. 4, each section 44 and 45 includes an elongate edge portion 50 and 51, respectively. The edge portions 50 and 51 each include a border portion 52 and 53, respectively, which comprise a peripheral portion of each section 44 and 45, respectively, and extend along edge portions 50 and 51, respectively. In that manner, sections 44 and 45 are oriented to extend substantially parallel to one another, with edge portions 50 and 51 overlapping one another such that border portions 52 and 53 overlap. A seam 60 is created between edge portions 50 and 51. “Substantially parallel” does not mean that the sections 44 and 45 are necessarily precisely parallel. They may be out of precise coplanar alignment due, for example, to the thickness of the conductor member 42.

Conductor member 42 is substantially similar to conductor member 16 described above, having a tab portion 61 corresponding to tab portion 20 described above and a pad portion 62 corresponding to pad portion 18 described above. Like conductor member 16, conductor member 42 can be any of the embodiments disclosed above. In this embodiment, conductor member 42 is a multi-layered construction of a nonconductive, flexible organic polymer substrate 63 having an organosulfur surface 64, a metallic layer 65 adhered thereto, and, optionally, a metallic halide layer 66, produced according to the disclosure of U.S. Pat. No. 5,506,059 described above. The pad portion 62 of conductor member 42 is attached to a portion of the conductive adhesive 70. Because depolarizing is not needed for the mechanical and electrical contact with electrical equipment, metallic halide layer 66 need not extend to tab portion 61. Optionally, an adhesively-backed polyethylene tape can be applied to tab portion 61 in the same manner as that for the embodiment of FIGS. 2 and 3 in order to enhance mechanical contact.

In general, grounding electrode 40 is constructed such that tab portion 61 of conductor member 42 projects through seam 60 and over a portion of surface or side 47. As a result, as seen in FIGS. 4 and 5 pad portion 62 of conductor member 42 is positioned on one side 46 of insulator layer 41, and the tab portion 61 of conductor member 42 is positioned on an opposite side 47 of insulator layer 41. It will be understood that except where tab portion 61 extends through seam 60, the seam may be sealed by means of an adhesive or the like.

As seen in FIG. 5, lower surface 68 of tab portion 61 is shown adhered in position to section 45, by means of double-stick tape strip 69 underneath tab portion 61. A conductive adhesive 70, typically biocompatible, is shown positioned generally underneath conductive member 42. Optionally, conductive adhesive 70 may be surrounded by a non-conductive biocompatible adhesive 71. A layer of release liner 75 is shown positioned against that side of grounding electrode 40 which has optional non-conductive biocompatible skin adhesive 71 and conductive adhesive 70 thereon. Adhesive useful as double stick tape strip 69 can be any of the acrylate ester adhesives described above. A presently preferred adhesive for double stick tape strip 69 is the same adhesive as presently preferred for the non-conductive biocompatible adhesive except having an inherent viscosity of about 1.3-1.45 dl/g.

The conductive adhesive 70 may be any of the materials also suitable for conductive adhesive 14, above. A variety of materials may be used as the biocompatible skin adhesive 71. Typically, acrylate ester adhesives will be preferred. Acrylate ester copolymer adhesives are particularly preferred. Such materials are generally described in U.S. Pat. Nos. 2,973,826; Re 24,906; Re 33,353; 3,389,827; 4,112,213; 4,310,509; 4,323,557; 4,732,808; 4,917,928; 4,917,929; and European Patent Publication 0 051 935, all the disclosures of which are incorporated herein by reference. In particular, an adhesive copolymer having from about 95 to about 97 weight percent isooctyl acrylate and from about 5 to about 3 percent acrylamide and having an inherent viscosity of 1.1-1.25 dl/g is presently preferred.

Optionally as shown in FIG. 5, a spacer 76 can be positioned between release liner 75 and biocompatible skin adhesive 71 to facilitate the separation. A variety of release liners 75 may be utilized; for example, a liner comprising a polymer such as a polyester or polypropylene material, coated with a silicone release type coating which is readily separable from the biocompatible skin adhesive and conductive adhesive.

A variety of materials may be used to form the sections 44 and 45 of the insulator layer 41. In general, a flexible material is preferred which will be comfortable to the user and is relatively strong and thin. Preferred materials are polymer foams, especially polyethylene foams, non-woven pads, especially polyester non-wovens, various types of paper, and transparent films. Nonlimiting examples of transparent films include polyester films such as those commercially available as MELINEX polyester film from ICI Americas, Hopewell, Va. having a thickness of 0.05 mm and a surgical tape commercially available from 3M Company as TRANSPORE unembossed.

The most preferred materials are non-woven pads made from melt blown polyurethane fiber, which exhibit exceptional flexibility, stretch recovery and breathability. Melt blown polyurethane materials usable in insulator layer 41 in grounding electrodes according to the present invention are generally described in European Patent Publication 0 341 875 (Meyer) and corresponding U.S. Pat. No. 5,230,701 (Meyer et al.), the disclosures of which are incorporated herein by reference.

Preferred web materials (melt blown polyurethanes) for use in insulator layer 41 have a web basis weight of about 60-140 g/m² (typically about 120 g/m²). Such materials have an appropriate tensile strength and moisture vapor transmission rate. A preferred moisture vapor transmission rate is about 500-3000 grams water/m²/24 hours (typically 500-1500 grams water/m²/24 hours) when tested according to ASTM E96-80 at 21° C. and 50% relative humidity. An advantage to such materials is that webs formed from them can be made which exhibit good elasticity and stretch recovery. This means that the grounding electrode can stretch well, in all directions, with movement of the person, without loss of electrode integrity and/or failure of the seal provided by the non-conductive biocompatible adhesive. Material with a stretch recovery of at least about 85%, in all directions, after stretch of 50% is preferred.

A variety of dimensions may be used for the grounding electrode disclosed herein. Generally an insulator layer of about 3.5-4.5 cm by 5.5-10 cm will be quite suitable for typical foreseen applications. A thickness of about 200 to 600 μm provides for adequate strength and a desired low relief or profile, in typical applications.

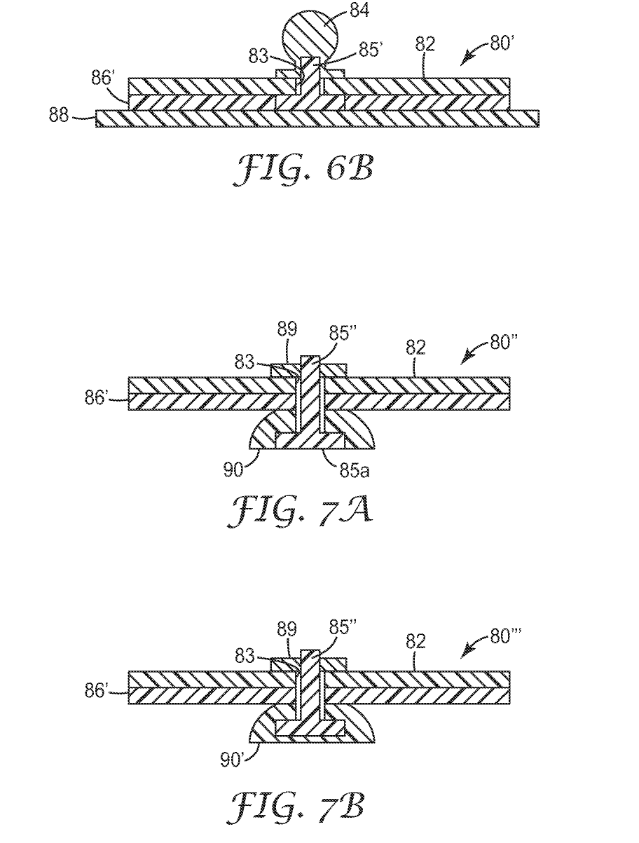

Another grounding electrode construction is shown in FIG. 6A in cross-section. Grounding electrode 80 has a nonconductive backing 82 having an opening 83, covered by snap 84, through which stud or eyelet 85 protrudes. The snap 84 is secured to eyelet 85 to provide a point of electrical connection to a grounding wire or other electrical instrumentation. Covering eyelet 85 and backing 82 is a conductive biocompatible adhesive 86. A release liner 88 protects the biocompatible adhesive 86 prior to use. Backing 82 can be made of the same or similar materials as insulator layer 41. Eyelet 85 may be a plastic, metallic-plated eyelet (such as an ABS plastic eyelet silver-plated and chlorided and commercially available from Micron Products of Fitchburg, Mass.). Snap 84 may be a metallic snap (such as stainless steel eyelet No. 304 commercially available from Eyelets for Industry of Thomason, Conn.). Grounding electrode 80 is particularly preferred because a single type of adhesive can serve both as the biocompatible skin adhesive and as the conductive medium in grounding electrode 80.

FIG. 6B illustrates a grounding electrode 80′ similar to that of FIG. 6A except that eyelet 85′ extends through the entire depth of biocompatible adhesive 86′ such that it will contact the object to be grounded when release liner 88 is removed and grounding electrode 80′ is applied to the object. In this embodiment, biocompatible adhesive 86′ may be conductive or nonconductive. Because eyelet 85′ directly contacts the object, biocompatible adhesive 86′ need not be a conductive adhesive.

FIG. 7A illustrates grounding electrode 80″ in which the top portion of eyelet 85″ is held in place adjacent backing 82 by retainer 89 and the bottom portion of eyelet 85″ is partially enclosed by encasement 90, which holds the bottom portion of eyelet 85″ in place between biocompatible adhesive 86′ and the object to be grounded. Encasement 90 may be any suitable shape. It may be conductive or nonconductive, but is preferably conductive plastic. The use of encasement 90 can allow eyelet 85″ to be made of an inexpensive metal that would normally corrode when exposed to skin or atmospheric elements. If encasement 90 is conductive, the bottom surface 85a of 85″ may be sealed, e.g., with a non-conductive or conductive material such as an adhesive tape or a coated sealant. In this case electricity would be conducted from the skin through encasement 90 to eyelet 85″. If encasement 90 is non-conductive, the bottom surface 85a of 85″ may be sealed with a conductive material such as an anisotropically conductive adhesive tape or a coated conductive sealant. In this case electricity would be conducted from the skin through the conductive sealing material to eyelet 85″.

FIG. 7B illustrates grounding electrode 80′″ in which the top portion of eyelet 85″ is held in place adjacent backing 82 by retainer 89 and the bottom portion of eyelet 85″ is fully enclosed by encasement 90′, which contacts the object to be grounded. Encasement 90′ may be any suitable shape. In this embodiment, encasement 90′ is conductive and is preferably plastic. The use of encasement 90′ can allow eyelet 85″ to be made of an inexpensive metal that would normally corrode when exposed to skin or atmospheric elements. Electricity is conducted from the skin through encasement 90′ to eyelet 85″.

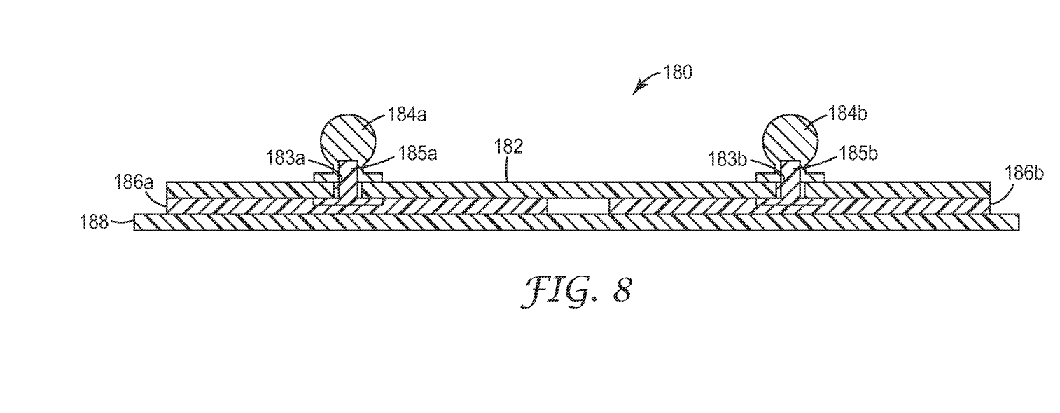

FIG. 8 illustrates dual conductor grounding electrode 180. The dual conductor grounding electrode can have any suitable structure so long as the conductive portions are electrically separated from each, i.e., do not make electrical contact through the structure of the grounding electrode itself. For example, dual conductor grounding electrode 180 includes two eyelets 185a, 185b that are not in electrical contact with each other. Dual conductor grounding electrode 180 is similar to grounding electrode 80 of FIG. 6B, but with some duplicate elements. It has a single nonconductive backing 182 having opening 183a and 183b covered, respectively, by snaps 184a and 184b through which eyelet 185a and 185b respectively protrude. The snaps 184a, 184b are secured to the eyelets to provide a point of electrical connection to another device or object. Covering a substantial portion of backing 182 and respectively surrounding eyelets 185a, 185b are conductive biocompatible adhesives 186a and 186b. The type of adhesives in 186a and 186b may be different or the same, but they are electrically separated from each other, typically by physical separation, so that they do not allow eyelets 185a and 185b to be in electrical contact with each other. A single release liner 188 extends across the surfaces of both biocompatible adhesives 186a and 186b and protects them prior to use.

The dual conductor grounding electrode can be used in conjunction with a dual conductor ground cord. The dual system allows for a monitored loop resistance measurement, which includes the grounding electrode eyelets' contact to the object to be grounded and a redundant ground path. If one conductor of the system fails, the other can still function thus maintaining the grounding of the object to be grounded. As a result, this prevents static from being generated by the object to be grounded (typically a person) eliminating possible damage to an static-sensitive materials in contact with the object to be grounded, such as static-sensitive electronic components. Any suitable dual conductor cord can be used with the dual conductor grounding electrode. Examples of dual conductor cord suitable for use with the dual conductor grounding electrode include the 3M Dual Conductor Cord 2300 Series and the DWCC Dual Conductor Cord series, both available from 3M Company, St. Paul, Minn.

Other examples of grounding electrodes which can be used in the present invention include electrodes disclosed in U.S. Pat. Nos. 4,527,087; 4,539,996; 4,554,924; 4,848,353 (all Engel); 4,846,185 (Carim); 4,771,713 (Roberts); 4,715,382 (Strand); 5,133,356 (Bryan et al.), the disclosures of which are incorporated herein by reference.

The grounding electrodes of the present invention may be used in various arrangements and applications. In some arrangements, instead of attaching the grounding electrode to an object to be grounded, the grounding electrode may be attached, e.g., adhered, to a grounded object. For example, a grounding electrode can be attached to a metal floor or conductive mat. A grounding cord can then be attached, e.g., snapped, to the grounding electrode and attached to another device that is attached to an object to be grounded, e.g., a wrist strap worn by a person. In other arrangements, the grounding cord to which the grounding electrode is attached may be connected to another grounding cord which is, in turn, attached to another grounding electrode. This can provide grounding arrangements in which, effectively, grounding electrodes on each end of a grounding wire can be adhered to a surface. In an alternative arrangement, two grounding electrodes with grounding cords attached can be adhered together such that each end has a grounding cord available to connect to an object to be grounded or a grounded object. In a similar manner, a long grounding cord can be created by connecting together a series of grounding electrodes with grounding cords. With at least one of the described arrangements, various grounded objects and objects to be grounded can be electrically connected. For example, a cart can be grounded to a metal floor and a pipe can be grounded to a conductive mat.

The grounding electrodes of the present invention may also be used for functions other than grounding. For example, they can be used as a docking station for grounding wires or cords when an operator detaches a grounding wire from the grounding electrode on his person such as when an operator needs to step away from his station. Instead of allowing the detached grounding wire to dangle, the grounding wire may be attached to a different grounding electrode that is adhered on or near the operator's work station. When used in this manner, the grounding electrode may be adhered to a conductive or insulative substrate.

The grounding electrode can also be used as part of a monitoring system. For example the grounding electrode can be attached, e.g., adhered, to a mat surface on which ESD sensitive products are placed. The grounding electrode can be connected to a monitoring device to monitor any electrostatic discharge to which the products on the mat are subjected.

### EXAMPLES

### Test Methods

### Set-Up Procedures

1. Equipment Setup and Preparation

Install 1,000 lb. Reversible Load Cell, available as Model # 2511-301 from Instron, Norwood, Mass., on a Dual-Column Tensile Tester, available as Model # 5567 from Instron. Calibrate Tensile Tester according to manufacturer's directions for 1,000 lb. load cell. Set cross-head speed to 12″/min. Wash all stainless steel panels with a fresh cleaning tissue soaked in acetone, and dry with another cleaning tissue. Wash all stainless steel panel again with a fresh cleaning tissue soaked in n-heptane, and dry with another cleaning tissue. Allow the panel to dry for 60 seconds to ensure that all solvent is absent from the surface.

2. Sampling

Run five tests on any sample of material.

### 90° Peel Test

Apply designated electrode to the approximate center of the stainless steel panel, then secure using a 5 lb. hand roller, four passes in each direction (vertically on each side of the stud eyelet and horizontally on each side of the stud eyelet). After 60 seconds insert stainless steel panel into the horizontal fixture grip attached to the lower jaw of the Tensile Tester. Slightly peel back the electrode and attach the edge of a 4 in. long and ½ in. wide strip of paper to the underside of the peeled backed portion. Secure the prepared substrate panel to the 90° peel test fixture and then clamp the free end of the paper strip into the upper jaw of the Tensile Tester. Start the crosshead in motion and allow test to run to completion. Record the maximum peel force in grams reported by the Tensile Tester software.

### Obtuse Peel Back Test

Repeat steps a, b, and c-i through c-iv from 90° Peel Test method. Push the lateral translation stage of the horizontal 90° peel fixture to its maximum allowable extreme. While holding the fixture in this position, start the crosshead in motion and do not release the fixture until the testing has completed. Record the maximum peel force in grams reported by the Tensile Tester software.

### Modified 90° Peel Test (Removal Method)

Repeat steps “a” through “c-ii” from 90° Peel Test method. Spread a dollop of 3M NEXCARE Advanced Skin Cream on the top (exposed) surface of the electrode, ensuring to coat the entire surface. Allow the cream to saturate into the pores of the electrode backing for 45 seconds. Secure the prepared substrate panel to the 90° peel test fixture and clamp the free end of the paper strip into the upper jaw of the Tensile Tester. Start the crosshead in motion and allow test to run to completion. Record the maximum peel force in grams reported by the Tensile Tester software.

### Multi-Use Pass/Fail Adhesion Test

Apply the electrode to designated surface using a 5 lb. hand roller. Wait 60 seconds then attach (snap) a 3M Wrist Strap Ground Cord Model 2210 (5 ft. long) to the electrode. Pull the unattached end of the ground cord in various directions and angles until either (a) the snap fails or (b) the adhesive fails.

Pass=the snap attaching the cord and the electrode detaches prior to any adhesion failure.

Fail=the electrode loses adhesion and completely detaches from the surface to which it is adhered.

### Example 1

Samples 1A to 1E were 3M RED DOT Pedriatic Monitoring Electrodes with Micropore Tape Backing 2248-50, available from 3M Company, St. Paul, Minn. The 2248-50 RED DOT electrode includes a round (4.4 cm. diam) 3M MICROPORE Surgical Tape backing with a solid gel conductive adhesive.

The samples were tested by the 90° Peel Test, Obtuse Peel Back Test, and Modified 90° Peel Test. The results are shown below in Table 1. The value given is the maximum load the sample was able to withstand without failing.

TABLE 1

| | 90° Peel | Obtuse Peel Back | Modified 90° Peel |
|---|---|---|---|
| Example | (grams) | (grams) | (grams) |
| 1A | 612.4 | 454.0 | 424.8 |
| 1B | 489.4 | 567.5 | 485.8 |
| 1C | 684.2 | 385.1 | 459.0 |
| 1D | 468.1 | 499.9 | 435.7 |
| 1E | 605.6 | 509.8 | 441.9 |
| Average | 571.94 | 483.26 | 449.44* |

*% change from 90° Peel = −21.4%

### Example 2

Samples 2A to 2E were 3M RED DOT Infant Soft Cloth Monitoring Electrode 2258-3. The 2258-3 RED DOT electrode includes a round (3.2 cm. diam) soft cloth backing, without abrader, available from 3M Company, St. Paul, Minn. In particular, the electrode includes a soft cloth tape backing, synthetic (acrylate) rubber adhesive, polyurethane sponge, stainless steel stud, polyethylene backing, removeable paperliner, Ag/AgCl coated eyelet, and a solid conductive gel.

The samples were tested by the 90° Peel Test, Obtuse Peel Back Test, and Modified 90° Peel Test. The results are shown below in Table 2. The value given is the maximum load the sample was able to withstand without failing.

TABLE 2

| | 90° Peel | Obtuse peel Back | Modified 90° Peel |
|---|---|---|---|
| Example | (grams) | (grams) | (grams) |
| 2A | 397.3 | 132.8 | 41.3 |
| 2B | 357.7 | 126.8 | 114.0 |
| 2C | 249.8 | 130.4 | 89.6 |
| 2D | 282.8 | 196.9 | 104.2 |
| 2E | 197.4 | 152.1 | 126.1 |
| Average | 297.00 | 147.80 | 95.06* |

*% change from 90° Peel = −68.0%

### Example 3

Samples 3A to 3E were 3M RED DOT Monitoring Electrode with Foam Tape and Sticky Gel 2560, available from 3M Company, St. Paul, Minn. The electrode includes a Polyethylene film, Ag/AgCl eyelet, stainless steel or radiolucent stud, foam backing, nonwoven polypropylene scrim, an adhesive/conductive sticky gel, and an abrader pad.

The samples were tested by the 90° Peel Test and Obtuse Peel Back Test. The results are shown below in Table 3. The value given is the maximum load the sample was able to withstand without failing. The samples were not subjected to the Modified 90° Peel Test because the applied cream was not able to penetrate the foam and interfered with the adhesion of the electrode.

TABLE 3

| | 90° Peel | Obtuse peel Back |
|---|---|---|
| Example | (grams) | (grams) |
| 3A | 2283 | 2296 |
| 3B | 3369 | 2019 |
| 3C | 3444 | 2512 |
| 3D | 2919 | 2308 |
| 3E | 2583 | 2165 |
| Average | 2919.6 | 2260.2 |

### Example 4

Samples 4A to 4E were 3M RED DOT Resting EKG Electrode 2352, available from 3M Company, St. Paul, Minn. The RED DOT 2352 electrode is 4.5 cm×2.2 cm and has a foam backing, a metal snap and a conductive sticky gel adhesive.

The samples were tested by the 90° Peel Test and Obtuse Peel Back Test. The results are shown below in Table 4. The value given is the maximum load the sample was able to withstand without failing. The samples were not subjected to the Modified 90° Peel Test because the applied cream was not able to penetrate the foam and interfered with the adhesion of the electrode.

TABLE 4

| | 90° Peel | Obtuse peel Back |
|---|---|---|
| Example | (grams) | (grams) |
| 4A | 1478 | 173.7 |
| 4B | 1300 | 106.1 |
| 4C | 1592 | 132.8 |
| 4D | 1490 | 121.3 |
| 4E | 1501 | 150.4 |
| Average | 1472.20 | 136.86 |

### Example 5

Samples 5A to 5K were 3M RED DOT Monitoring Electrode with Foam Tape and Sticky Gel 2560, as described above.

The samples were tested by the Multi-Use Pass/Fail Adhesion Test. The results are shown below in Table 5.

TABLE 5

| Sample | Test Surface | Adhesion |
|---|---|---|
| | Work Surfaces | |
| 5A | 3M ™ Dissipative Vinyl Three-Layer Mats and | Pass |
| | Runners | |
| 5B | 3-Layer Vinyl: 8200 Series | Pass |
| 5C | 3M ™ Dissipative Hard Laminate Sheet (8300) | Pass |
| 5D | 3M ™ Static Control Anti-Fatigue Runner (9500) | Pass |
| 5E | 3M ™ Static Control Anti-Fatigue Mat (9920- | Pass |
| | Octagonal) | |
| | Flooring | |
| 5F | Dissipative Vinyl floor tile (8414) | Pass |
| 5G | Conductive Vinyl floor tile (8434) | Pass |
| | Unconventional Surfaces | |
| 5H | Electrical Outlet | Pass |
| 5I | Metal Waste Disposal Drum | Pass |
| | Other: | |
| 5J | Velostat 383 | Pass |
| 5K | 741 Shoe Electrode | Pass |

Although specific embodiments have been illustrated and described herein, it will be appreciated by those of ordinary skill in the art that a variety of alternate and/or equivalent implementations may be substituted for the specific embodiments shown and described without departing from the scope of the present invention. Therefore, it is intended that this invention be limited only by the claims and the equivalents thereof.

1. An article comprising:
an electrode having an insulating backing, a conductive path extending from a first major surface to a second major surface of the insulating backing, and an adhesive on at least one surface of the backing,
wherein the electrode is attached to a grounding wire that is in electrical contact with the conductive path of the electrode.

2. The article of claim 1 wherein the electrode is a medical grade electrode.

3. The article of claim 1 wherein the electrode is repositionable.

4. The article of claim 1 wherein the adhesive is conducting and forms part of the conductive path.

5. The article of claim 1 wherein the adhesive is non-conducting.

6. The article of claim 1 wherein the adhesive covers an entire major surface of the backing.

7. The article of claim 1 wherein the adhesive covers only a portion of a major surface of the backing.

8. The article of claim 1 wherein the conducting path of the electrode further comprises a snap.

9. The article of claim 1 wherein the adhesive is biocompatible.

10. The article of claim 1 wherein the electrode is substantially conformable.

11. The article of claim 1 wherein the grounding wire is releasable.

12. The article of claim 1 wherein a second electrode is attached to the opposite end of the grounding wire.

13. The article of claim 1 wherein the electrode comprises two conductive paths extending from a first major surface to a second major surface of the backing, which conductive paths are electrically separated from each other.

14. A method comprising:
providing an electrode having an insulating backing, a conductive path extending from a first major surface to a second major surface of the insulating backing, and an adhesive on at least one side of the backing,
wherein the electrode is attached to a grounding wire that is in electrical contact with the conductive path of the electrode;
adhering the electrode to on object to be grounded, and
attaching the free end of the grounding wire to a grounded object.

15. A method comprising:
providing an electrode having an insulating backing, a conductive path extending from a first major surface to a second major surface of the insulating backing, and an adhesive on at least one side of the backing,
wherein the electrode is attached to a grounding wire that is in electrical contact with the conductive path of the electrode;
attaching the free end of the grounding wire to an object to be grounded, and
adhering the electrode to on object that is grounded.

16. A kit comprising:
an electrode having an insulating backing, a conductive path extending from a first major surface to a second major surface of the insulating backing, and an adhesive on at least one surface of the backing, and
a grounding wire that can be attached to the electrode such that it is in electrical contact with the conductive path of the electrode.

17. The kit of claim 16 wherein the conducting path of the electrode further comprises a snap.

18. The kit of claim 16 wherein the grounding wire is releasable.

19. The kit of claim 16 further comprising a second electrode that can be attached to the opposite end of the grounding wire.

20. The kit of claim 16 wherein the electrode comprises two conductive paths extending from a first major surface to a second major surface of the backing, which conductive paths are electrically separated from each other, and
wherein the grounding electrode is configured to such that it is in electrical contact with each conductive path of the electrode.
